(19) United States
(12) Patent Application Publication
(10) Pub. No.: US 2019/0366396 A1
(43) Pub. Date: Dec. 5, 2019

(54) Water jet containment tool.

(71) Applicants: John Reid, St. John, IN (US); Kevin Reid, Tinley Park, IL (US); Eric Reid, St. John, IN (US); Ryan Reid, St. John, IN (US); Rico Guillermo, St. John, IN (US)

(72) Inventors: John Reid, St. John, IN (US); Kevin Reid, Tinley Park, IL (US); Eric Reid, St. John, IN (US); Ryan Reid, St. John, IN (US); Rico Guillermo, St. John, IN (US)

(21) Appl. No.: 16/000,525

(22) Filed: Jun. 5, 2018

(51) Int. Cl. B08B 9/043

(52) U.S. Cl. CPC B08B 9/0433; B08B 2209/04; B08B 2209/032

(57) ABSTRACT

An enclosure for containing liquid that is expelled from a hose and nozzle at a high pressure. The enclosure allowing a user to withdraw the hose and nozzle from a pipe without the risk of harm to the user and without spraying liquid everywhere.

### BACKGROUND

Plumbing drain and sewer pipes regularly get clogged and require clearing. With regular water, a pump and a hose can be used to propel water at high pressures. A tool made for directing this high pressure water is called a jetter. A jetter hose can be inserted into a drain pipe. Plumbers direct the high pressure water jet coming from a jetter at the drain clogs. Such high pressure jet streams then dislodge the clog and clear the drainpipe.

Usually, there is a special head that fits onto the end of a jetter's hose. The head directs the highly pressurized water stream forward towards the clog, and also backward, and sideways. In effect the jetter stream is cutting at the clog while also clearing the inside of the drain, to and fro. The water jets are very strong and pose a risk for the user because the jets can easily cut human flesh.

Because of the dangers of high pressure water jetting, plumbers usually turn off the pumps before pulling the jetter's hose completely out of the pipe being cleared. Thus preventing the head is not outside of the pipe when it is jetting. This safety precaution has the negative effect of not clearing the pipe completely, essentially leaving debris in the drainpipe from the point the jetter is turned off. All plumbing drains, residential and business, are affected by clogs. Business establishments require frequent high-pressure water jetting. In every case, where a jetter is involved, there is a significant risk of danger to plumbers from the high pressure jets of water being expelled.

There is a need in the industry for an apparatus that is easy to use, inexpensive, and makes the use of high pressure water jetters a safer method for unclogging drains. Also desired, is a way to eliminate the need to turn a jetter off before it is completely removed from a drainpipe thereby leaving debris in the pipe.

### SUMMARY

The present invention is directed to an apparatus and process that satisfies this need, the utility of which is characterized by a hand tool that easily attaches to a pipe opening and provides an enclosure to regulate a jetting machine's water stream.

With regard to water jet clearing of plumbing clogs, an embodiment of the present invention involves a high-pressure water jet containment enclosure that is configured to contain a water jet during drainpipe cleaning operations. The water jet is most often expelled at a high pressure that is strong enough to dislodge stubborn clogs.

This embodiment of the enclosure comprises an open end that is configured to encircle a drainpipe opening. That drain pipe opening could be a clean-out, another hose that is attached to a drain, or a pre-fabricated head that is part of other tools made for boring out clean-out caps. There is a clamp connected to the open end that forms a hermetic seal between the enclosure and the drainpipe opening. This hermetic seal is important because of the high pressure of liquids, e.g. water, that are anticipated to be expelled in this cleaning operations.

The embodiment has a hose passage penetrating the enclosure. That passage is such that it slidably receives a water jet hose and lets the hose pass into the enclosure. There is necessarily a discharge conduit that drains liquid and solids from the enclosure during the cleaning operation. Additionally there is a valve attached to the discharge conduit that is configured to open and close the discharge aperture.

In addition, the embodiment could have a ring gasket mounted in the hose passage. That gasket would form a sliding seal between the hose passage and the water jet hose. This is beneficial because the user could easily slide the hose to and fro within the enclosure without water leaking out of the enclosure.

The containment enclosure works best with a diameter that is larger than the diameter of the water jet hose. The material of the enclosure must be able to contain, without rupturing, a water jet pressure in the range of 2000 pounds per square inch (psi) to 5000 psi. Though we think that any pressure used for this type of drain cleaning operation should be containable.

Another embodiment of the present invention for containing a water jet during drainpipe cleaning operations includes an enclosure body including an open end and a hose passage. The open end mounts easily to a drainpipe opening and the hose passage is configured to receive a water jet hose into the enclosure body. There is a coupling attached to the open end. The coupling forms a hermetic seal between the enclosure and the drainpipe opening. This includes a clamp configured to compress the coupling around the drainpipe opening.

The embodiment has a gasket mounted to the hose passage that slidably engages the water jet hose. The enclosure also has a discharge conduit penetrating the enclosure body that is located approximately medial the open end and the hose passage. This discharge conduit is configured to drain liquid or solids from the enclosure during the drainpipe cleaning operations. There would be a valve that can open or close the discharge conduit. The benefit being that the large amounts of water involved in this operation can be released in a controlled manner, discharged into a bucket for example.

We have found that the enclosure body is best if it is at least partly translucent or transparent. The benefit to watching and monitoring the jetter spray action is thereby facilitated. It too would have a high-pressure pump connected to the water jet hose, these j etters are commonly used in the industry, the high-pressure pump configured to pump water through the water jet hose at pressures ranging from 2000 psi to 5000 psi.

Yet another embodiment of the attachment for use with a drainpipe access tool, the attachment comprises an enclosure having at least one fastener. The drainpipe access tool is a hose, something that connects to a drainpipe opening, or a special head from another sort of tool such as the one developed by us under the Zipdrain® trademark. There is a spout. The spout and the enclosure are fixedly attached. We envision that the plastic enclosure and the plastic spout would be integrally made as part of its manufacturing process. There is a cavity, a valve, and a spout opening.

The spout opening is right next to the cavity and the valve is located within the cavity near the spout opening. The valve being operable by a handle that is located outside the cavity. The benefit of this is that the valve is capable of being operated and thereby modifying a passage, the waterway, that extends between the cavity and spout opening.

There is a washer that is interconnected between the cavity and outside of the enclosure via an aperture in the enclosure. There is a drainpipe and the enclosure has an opening. A collar is removably attached to a drainpipe opening, or to a drainpipe access tool which is contiguous with a drainpipe opening, and forms a pathway into the drainpipe. The benefit of having this pathway into the drainpipe is to allow guided and controlled entry of a water hose into the drainpipe from without the pipe.

There is at least one fastener demountably attached to the collar. Using a liquid pump capable of expelling liquid through an end of a hose. The hose slidably passing through the washer such that the end of the hose is enclosed by the cavity and passable into and out of the pathway into the drainpipe. The washer creates an hermetic seal with the hose.

In this embodiment, the liquid can be discharged through the spout opening and into a bucket. The benefit of this is to keep the work area clean. Also, the end of the hose can be a nozzle that expels the liquid at high pressures that can damage human skin. Because of the high pressures involved, the enclosure, made from a clear durable plastic so as to monitor the work, can withstand the force from liquids that are expelled by a pump at up to 5,000 pounds per square inch.

### BRIEF DESCRIPTION OF THE SEVERAL VIEWS OF THE DRAWINGS

These and other features, aspects and advantages of the present invention will become better understood with regard to the following description, appended claims, and accompanying drawings where:

FIG. 1 shows a side view of an embodiment of the present invention.

FIG. 2 shows a perspective view of another embodiment of the present invention being used on a drain pipe cleaning operation.

### DESCRIPTION

### Overview.

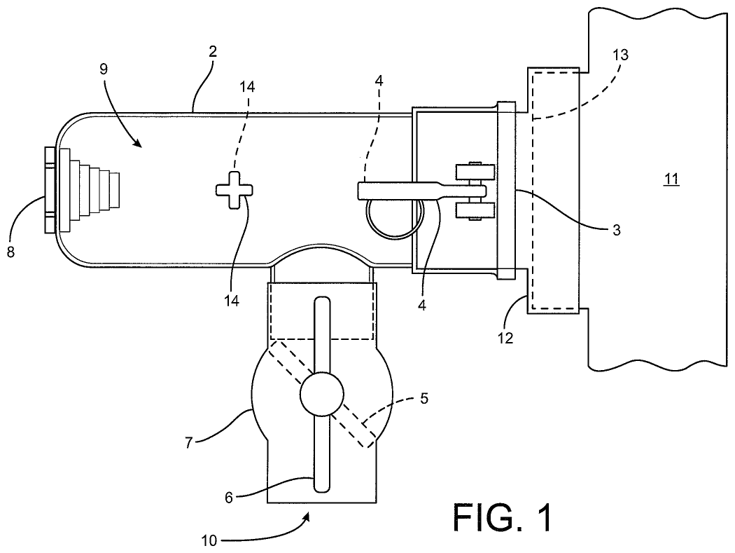

As shown in FIG. 1, an embodiment of the present invention comprises an enclosure 2 that is made of a durable see through plastic. The transparent property of the enclosure 2 is important because it allows a user to monitor the activity occurring within the cavity 9 of the enclosure 2. The enclosure 2 has an open end 3 attached to a drainpipe 11. Attaching is done by connecting the enclosure 2 at its open end 3 to a drainpipe opening 13. In this embodiment, the drainpipe opening 13 is part of an access tool 12.

The embodiment's enclosure 2 is secured to the access tool 12. For instance, clamps 4 on either side of the enclosure 2 can be closed to grasp the access tool 12. A strap (not shown) can be attached to the grabs 14 and wrapped around the drainpipe 11 to hold the enclosure in place.

When this embodiment of the tool is used by passing a water hose through the washer 8, there will accumulate a lot of water and debris within the cavity 9. That water will naturally flow out the opening 10 in a spout 6. That opening can be controlled, open or close, by operating the lever 6 which has a component part within the enclosure 5 that operates thereby. Interestingly, we have found that the washer 8 should be sealable to the hose (not shown) to prevent water from leaking out the hole in the washer 8.

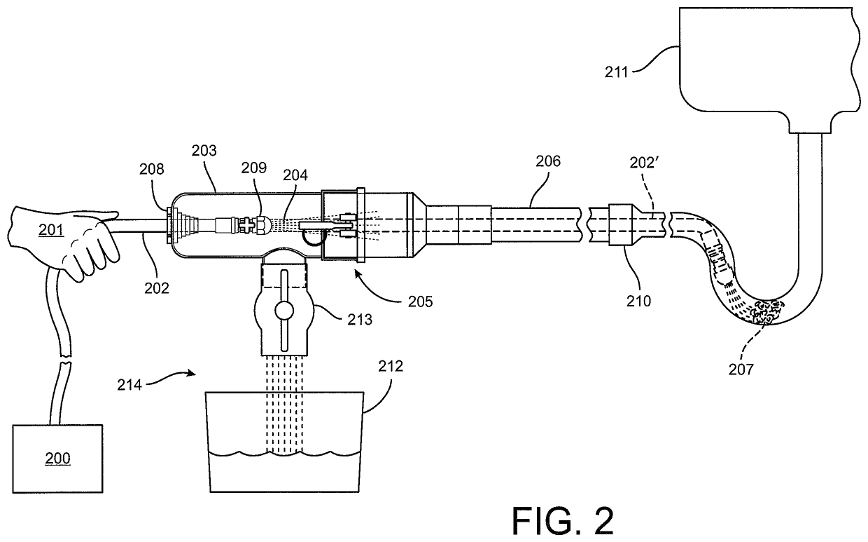

As shown in FIG. 2, another embodiment of the present invention being used in a drain pipe cleaning operation has a plumber 201 attempting to clean the pipes of a kitchen sink 211 that has a clog 207. The plumber uses a high pressure water pump 200 that pumps water through a water hose 202. The plumber 201 feeds the water hose 202 through a grommet 208 that is attached to one end of an enclosure 203. We found it best if the enclosure is made of a see-through plastic of such a strength to withstand great pressures, including, without limitation, those exerted by a highly pressurized water stream.

As is common in the plumbing industry, the hose 202 has a nozzle 209 connected to the hose end where the highly pressurized water stream 204 is expelled. It is widely known in the industry that this water stream is dangerous and can inflict great harm to a person. The enclosure 203 provides a novel benefit of containing that dangerous stream and preventing harm.

The enclosure 203 is connected at one end 205 to an accessing tool 206, in this case a hose with differently sized ends. The accessing tool 206 is connected to the drainpipe opening at its other end 210. This allows the plumber 201 to guide the hose 202 through the enclosure 203 and into the drainpipe through the drainpipe opening. As she 201 slides the hose 202 to a position further into the drainpipe 202′, the water stream acts on the clog 207 and thereby clear the drainpipe of the clog. Notably, the plumber is able to withdraw the nozzle 209 past the drainpipe opening even though the nozzle is expelling water 204 at a dangerous pressure. Previously, she would have had to stop the pump before removing the nozzle from a drainpipe. Doing that, however, would leave debris in the drainpipe. This embodiment of the invention allows withdrawing the nozzle 209 fully from the drainpipe and pulling with it all of the debris that was in the drainpipe, leaving none of it behind. All of this while preventing injury to the plumber because the enclosure 203 contains the dangerous water stream 204.

Because there is a large quantity of water involved in this type of drainpipe cleaning operation, this embodiment of the invention allows draining the water that was contained in the enclosure and within the drain system itself 214. This is done by opening or closing a valve that is located in a discharge conduit 213. The water is then expelled into a container 212.

Although the present invention has been described in considerable detail with the reference to certain preferred versions thereof, other versions are possible. The range of pressures that the enclosure can withstand could be greater than 5000 psi, or other liquids couple be involved besides water to name just two examples of other possible versions. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. § 112,¶6.

What we claim is:

1. An attachment to be used with a drainpipe access tool, the attachment comprising:
an enclosure;
at least one fastener;
a spout;
the enclosure being fixed to the spout;
a cavity;
a valve;
the spout having an opening;
the spout opening being incident to the cavity;
the valve being located within the cavity near the spout opening;
the valve being operable by a handle that is located outside the cavity;
the valve being capable of modifying a passage that extends between the cavity and spout opening;
a washer;
the washer being interconnected between the cavity and outside of the enclosure via an aperture in the enclosure;
a drainpipe;
the enclosure having an opening;
a collar;
the collar being removably attached to a drainpipe opening forming a pathway into the drainpipe;
at least one fastener being demountably attached to the collar;
a liquid pump capable of expelling liquid through an ed of a hose;
the hose slidably passing through the washer such that the end of the hose is enclosed by the cavity and passable into and out of the pathway into the drainpipe;
the washer creating an effective hermetic seal with the hose.

2. The attachment of claim 1, wherein the liquid discharges through the spout opening and into a bucket.

3. The attachment of claim 1, wherein the end of the hose is a nozzle that expels the liquid at pressures that can damage human skin.

4. The attachment of claim 1, wherein the enclosure is made of a clear durable plastic.

5. The attachment of claim 1, wherein the enclosure is capable of withstanding the force from liquids expelled at up to 5,000 pounds per square inch.

6. A high-pressure water jet containment enclosure, the enclosure configured to contain the water jet during drainpipe cleaning operations, the enclosure comprising:
an open end configured to encircle a drainpipe opening;
a clamp connected to the open end, the clamp configured to form a hermetic seal between the enclosure and the drainpipe opening;
a hose passage penetrating the enclosure, the hose passage configured to slidably receive a water jet hose into the enclosure;
a discharge conduit configured to drain liquid and solids from the enclosure; and
a valve attached to the discharge conduit, the valve configured to open and close the discharge aperture.

7. The containment enclosure of claim 6, further comprising a ring gasket mounted in the hose passage, the ring gasket configured to form a sliding seal between the hose passage and the water jet hose.

8. The containment enclosure of claim 6, wherein the enclosure as a diameter that is larger than a diameter of the water jet hose.

9. The container enclosure of claim 6, wherein the enclosure is configured to contain without rupture a water jet pressure in the range of 2000 pounds per square inch (psi) to 5000 psi.

10. A high-pressure water jet containment system for containing the water jet during drainpipe cleaning operations, the system comprising:
an enclosure body including an open end and a hose passage, the open end configured to mount to a drainpipe opening and the hose passage configured to receive a water jet hose into the enclosure body;
a coupling attached to the open end, the coupling configured to form a hermetic seal between the enclosure and the drainpipe opening, the coupling including a clamp configured to compress the coupling around the drainpipe opening;
a gasket mounted to the hose passage, the gasket configured to slidably engage the water jet hose;
a discharge conduit penetrating the enclosure body medial the open end and the hose passage, the discharge conduit configured to drain liquid and/or solids from the enclosure during the drainpipe cleaning operations; and
a valve configured to open and close the discharge conduit.

11. The containment system of claim 10, wherein the enclosure body at least partly translucent or transparent.

12. The containment system of claim 10, further comprising:
a high-pressure pump connected to the water jet hose, the high-pressure pump configured to pump water through the water jet hose at pressures ranging from 2000 psi to 5000 psi.

13. The containment system of claim 10, wherein the water jet hose is configured to extend through the enclosure body into the drainpipe opening, and further configured to flexibly navigate through bends and elbows in the drainpipe.

14. The containment system of claim 10, wherein the gasket is a step grommet.
